(19) United States
(12) Patent Application Publication
(10) Pub. No.: US 2009/0272207 A1
(43) Pub. Date: Nov. 5, 2009

(54) ROTARY ACTUATING MECHANISM HAVING SELECTABLE ROTARY WHEELS

(76) Inventors: Thomas John Buckingham, Novi, MI (US); David Michael Whitton, Saline, MI (US); James Joseph Kornacki, Dearborn, MI (US)

Correspondence Address: FRASER CLEMENS MARTIN & MILLER LLC, 28366 KENSINGTON LANE, PERRYSBURG, OH, 43551, US

(21) Appl. No.: 12/113,578

(22) Filed: May 1, 2008

(51) Int. Cl. F16H 35/18

(52) U.S. Cl. 74/10.41

(57) ABSTRACT

A rotary actuating mechanism for a center stack of a vehicle is disclosed including a knob and a plurality of rotary wheels. An indexing device, disposed adjacent the rotary actuating mechanism, includes a guide adapted to contact one of the rotary wheels and travel along the outer surface thereof to provide a desired tactile feel, wherein the guide is selectively positioned by one of a mechanical device and an electromechanical device.

### FIELD OF THE INVENTION

The invention relates to a rotary actuating mechanism and more particularly to a rotary actuating mechanism including a plurality of selectable rotary wheels.

### BACKGROUND OF THE INVENTION

The sense of touch is used in receiving tactile and kinesthetic cues from various tasks performed on a daily basis. Tactile cues are derived from textures, bumps, and vibrations, for example. Whereas, kinesthetic cues are based on shape, contours, and sensations like stirring thick paint, for example.

Typically, a rotary actuating mechanism provides a desired tactile feel by including detents or protuberances and requiring a certain amount of force from a user to rotate the mechanism.

In U.S. Pat. No. 4,647,889 entitled ROTARY CONTROL HAVING VARIABLE DETENTS, hereby incorporated herein by reference in its entirety, a rotary actuating mechanism is disclosed. The rotary actuating mechanism includes a plate having magnetizable flutes extending radially outwardly therefrom. Each of the flutes corresponds to a rotational stop position of the mechanism. Positioned adjacent the plate is a switchable electromagnet. A control switch selectably energizes the electromagnet to magnetically engage the flutes successively as the mechanism is rotated. The magnetic engagement of the flute stops the mechanism at each stop position until sufficient torque is applied by a user to overcome the resistance of the magnetic engagement. The switch also de-energizes the electromagnet so that the mechanism may be continuously variable.

Traditionally, the rotary actuating mechanism is limited in permitting the user to modify or select a different tactile feel. One such rotary actuating mechanism is disclosed in U.S. Pat. No. 5,862,715 entitled TACTILE DETENT KNOB, hereby incorporated herein by reference in its entirety. The rotary actuating mechanism, also referred to as a knob, is attached to a rotary shaft of a variable control element. The knob includes a plurality of detents to provide a plurality of discrete, different, tactile signals to a user, including discrete points of resistance to rotation of the shaft. However, a tactile effect of the knob is only changed by having to replace various components of the knob.

Presently, the PR-1000 Rotary Encoder manufactured by Immersion Corporation includes a programmable profile to provide multiple tactile feels to a user. Depending on the context of operation, the encoder can output different types of detents, add or subtract detents, and increase or decrease a range of motion, for example. However, the PR-1000 is well suited to very high end, more expensive applications such as interior components on luxury vehicles.

Although the aforementioned rotary actuating mechanisms operate effectively, the mechanisms either do not permit the user to dynamically change a tactile feel of the mechanism, require an addition or subtraction of components to do so, or are expensive.

Accordingly, it would be desirable to produce a rotary actuating mechanism adapted to permit a user to select from various tactile feels, wherein a cost and complexity thereof are minimized.

### SUMMARY OF THE INVENTION

In concordance and agreement with the present invention, a rotary actuating mechanism adapted to permit a user to select from various tactile feels, wherein a cost and complexity thereof are minimized, has surprisingly been discovered.

In one embodiment, the rotary actuating mechanism comprises a plurality of rotary wheels having an outer surface, wherein the outer surface of at least one of the rotary wheels includes at least one surface irregularity formed thereon; and an indexing device adapted to selectively engage one of the rotary wheels and travel along the outer surface thereof to provide a desired tactile feel.

In another embodiment, the rotary actuating mechanism for a vehicle comprises a plurality of rotary wheels having a generally smooth outer surface, wherein the outer surface of at least one of the rotary wheels includes at least one surface irregularity formed thereon; and an indexing device including a guide adapted to contact one of the rotary wheels and travel along the outer surface thereof to provide a desired tactile feel, wherein the guide is selectively positioned by one of a mechanical device and an electro-mechanical device.

In another embodiment, the control module for a vehicle comprises a face plate having at least one switch disposed thereon; a rotary actuating mechanism including a knob and a plurality of rotary wheels having a generally smooth outer surface, wherein the knob extends through an aperture formed in the face plate, and wherein the outer surface of at least one of the rotary wheels includes at least one surface irregularity formed thereon; and an indexing device including a guide adapted to contact one of the rotary wheels and travel along the outer surface thereof to provide a desired tactile feel, wherein the guide is selectively positioned by one of a mechanical device and an electro-mechanical device.

### BRIEF DESCRIPTION OF THE DRAWINGS

The above and other objects and advantages of the invention will become readily apparent to those skilled in the art from reading the following detailed description of the invention when considered in the light of the accompanying drawings, in which:

FIG. 1 is a front elevational view of a control module including a rotary actuating mechanism according to an embodiment of the invention;

FIG. 2 is an enlarged fragmentary top plan view partially in section of the control module illustrated in FIG. 1 according to another embodiment of the invention;

FIG. 3 is an enlarged rear elevational view of the rotary actuating mechanism illustrated in FIG. 2;

FIG. 4 is an enlarged fragmentary top plan view partially in section of the control module illustrated in FIG. 1 according to another embodiment of the invention;

FIG. 5 is an enlarged fragmentary top plan view partially in section of the control module illustrated in FIG. 1 according to another embodiment of the invention;

FIG. 6 is an enlarged rear elevational view of the rotary actuating mechanism illustrated in FIG. 5; and

FIG. 7 is an enlarged rear elevational view of the rotary actuating mechanism illustrated in FIG. 1 according to another embodiment of the invention.

### DETAILED DESCRIPTION OF THE PREFERRED EMBODIMENTS OF THE INVENTION

The following detailed description and appended drawings describe and illustrate various exemplary embodiments of the present invention. The description and drawings serve to enable one skilled in the art to make and use the invention, and are not intended to limit the scope of the invention in any manner. It is understood that materials other than those described can be used without departing from the scope and spirit of the invention.

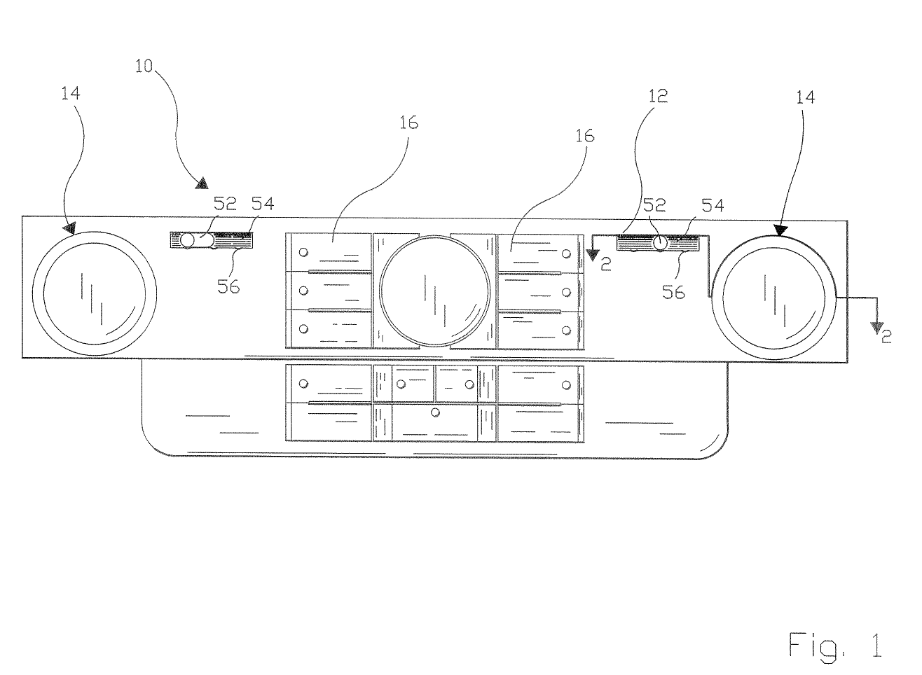

FIG. 1 shows a control module 10 for a vehicle center stack (not shown) according to an embodiment of the invention. The control module 10 includes a face plate 12, at least one rotary actuating mechanism 14, and at least one switch 16. It is understood that the rotary actuating mechanism 14 can be employed in other applications as desired. It is also understood that the at least one switch 16 can be any switch type such as a pushbutton, a dial, and the like, for example.

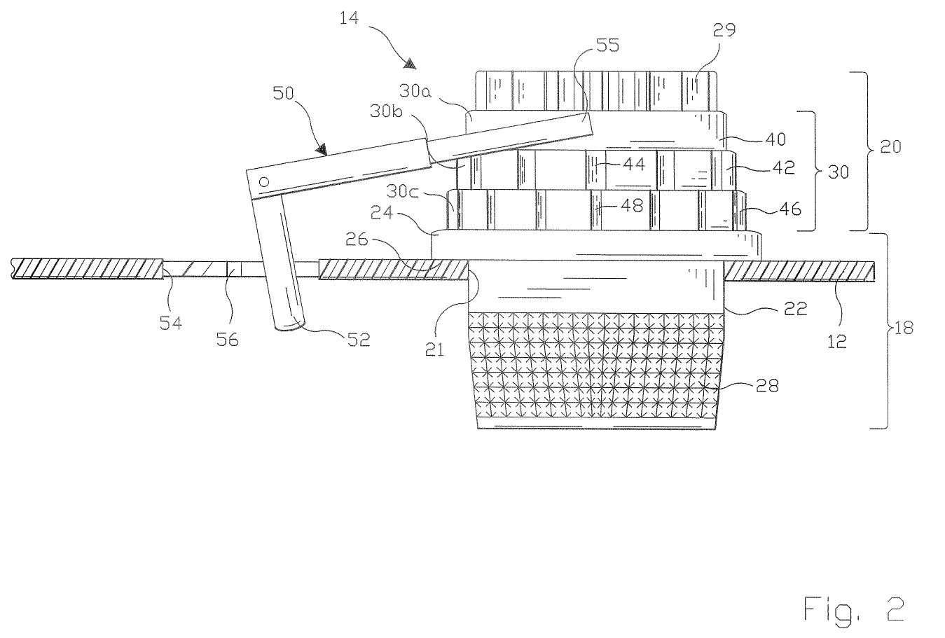

As shown in FIGS. 2, 3 and 4, the rotary actuating mechanism 14 has a generally cylindrical shape, although it is understood that the rotary actuating mechanism 14 can have other shapes as desired. The rotary actuating mechanism 14 includes a first portion 18 and a second portion 20. The first portion 18 extends through an aperture 21 formed in the face plate 12. An outer surface 22 of the first portion 18 is received in the aperture 21 and terminates at an annular flange 24. The annular flange 24 has a first surface 26 adapted to abut a back side of the face plate 12. In the embodiment shown, the first portion 18 is a knob having a plurality of grips 28 formed thereon.

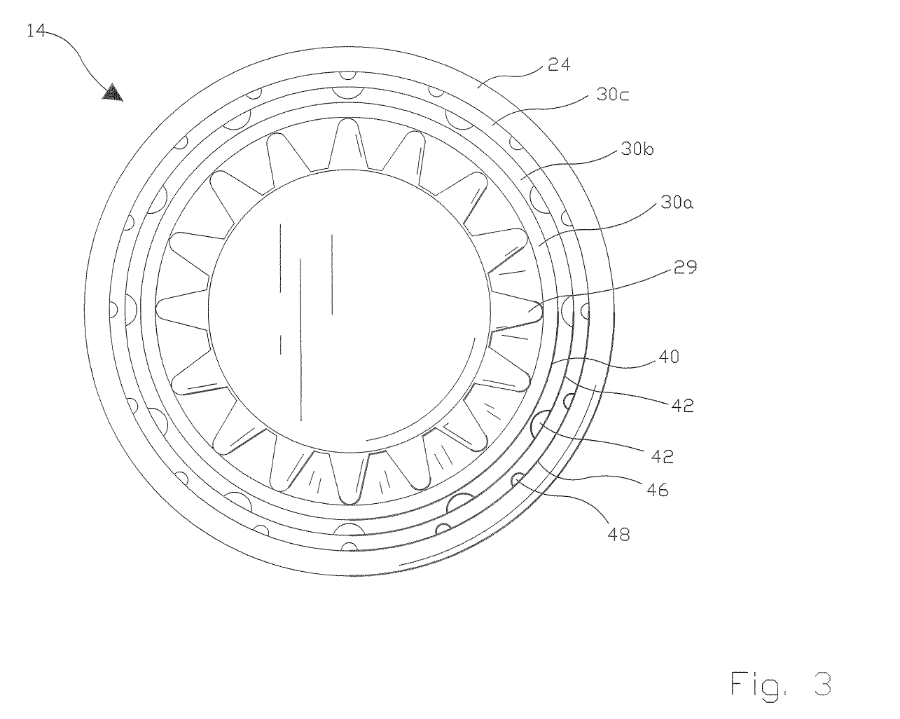

The second portion 20 includes a gear 29 and a plurality of rotary wheels 30. The gear 29 is adapted to drive an encoder (not shown) or a potentiometer (not shown) to interface with an electrical system (not shown) of the vehicle. As illustrated, the second portion 20 further includes a first rotary wheel 30a, a second rotary wheel 30b, and a third rotary wheel 30c. It is understood that the second portion 20 can include more or less rotary wheels 30 if desired. The rotary wheels 30 shown are integrally formed, although it is understood that the rotary wheels 30 can be formed separately if desired. In the embodiment shown, the first rotary wheel 30a has a generally smooth outer surface 40 adapted to provide a sensation of constant resistance. It is understood that the first rotary wheel 30a can be adapted to provide any tactile feel as desired. The second rotary wheel 30b shown has a generally smooth outer surface 42 having at least one surface irregularity 44 formed therein such as an indentation as shown in FIG. 3, a protuberance, a detent, and the like, for example. In the embodiment shown, the surface irregularities 44 are uniformly spaced at a predetermined distance to provide a sensation of less resistance at a discrete number of positions. Although, it is understood that the second rotary wheel 30b can be adapted to provide any tactile feel as desired. The third rotary wheel 30c has a generally smooth outer surface 46 having at least one surface irregularity 48 formed therein such as an indentation as shown in FIG. 3, a protuberance, a detent, and the like, for example. In the embodiment shown, the surface irregularities 48 are uniformly spaced at a predetermined distance to provide a desired tactile feel. The predetermined distance of the surface irregularities 48 of the third rotary wheel 30c is less than the predetermined distance of the surface irregularities 44 of the second rotary wheel 30b. The desired tactile feel for the third rotary wheel 30c is a sensation of less resistance at a discrete number of positions. Although, it is understood that the third rotary wheel 30c can be adapted to provide any tactile feel as desired.

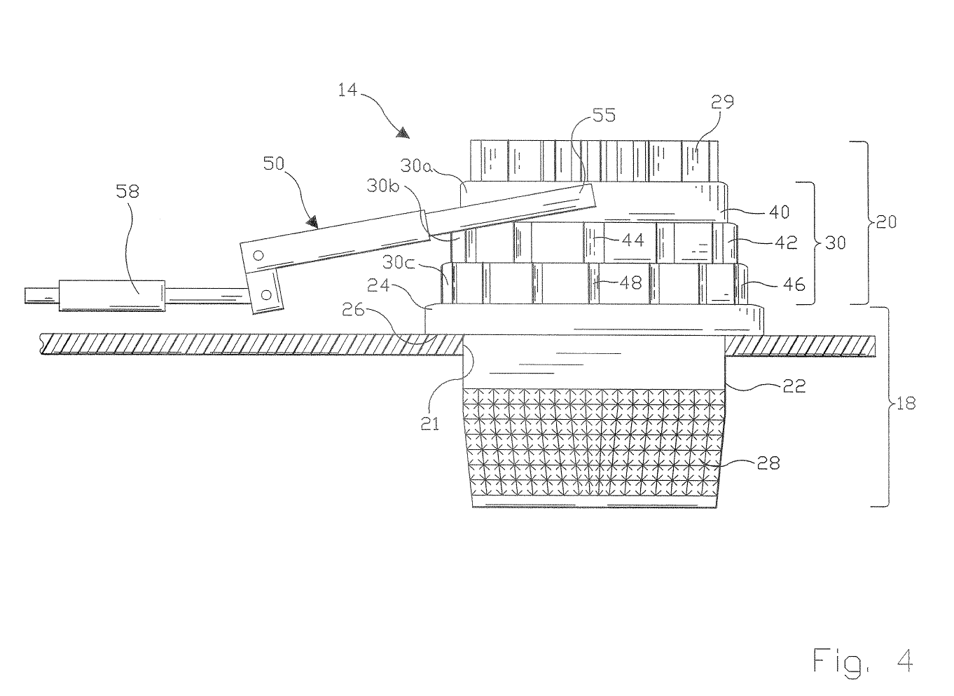

An indexing device 50 is disposed adjacent the rotary actuating mechanism 14. The indexing device 50 is adapted to be positioned on one of the rotary wheels 30 and travel along the outer surface 40, 42, 46 thereof. As illustrated in FIG. 2, the indexing device 50 includes a lever 52 extending through a slot 54 formed in the face plate 12. The lever 52 is accessible to a passenger of the vehicle and is adapted to selectively position a guide 55 of the indexing device 50 as desired. The slot 54 may include at least one groove 56 adapted to receive the lever 52 therein at a desired position of the indexing device 50. Alternatively, the indexing device 50 may include a solenoid 58, as shown in FIG. 4. The solenoid 58 is adapted to cooperate with the at least one switch 16 disposed on the face plate 12 to position the guide 55 of the indexing device 50. It is understood that the indexing device 50 can be positioned by other mechanical and electromechanical means accessible to the passenger of the vehicle as desired. It is further understood a position of the indexing device 50 may be monitored using a detector switch (not shown) or by other means of position detection if desired. Position information is useful if a function or a tactile feel of the rotary actuating mechanism 14 is changed.

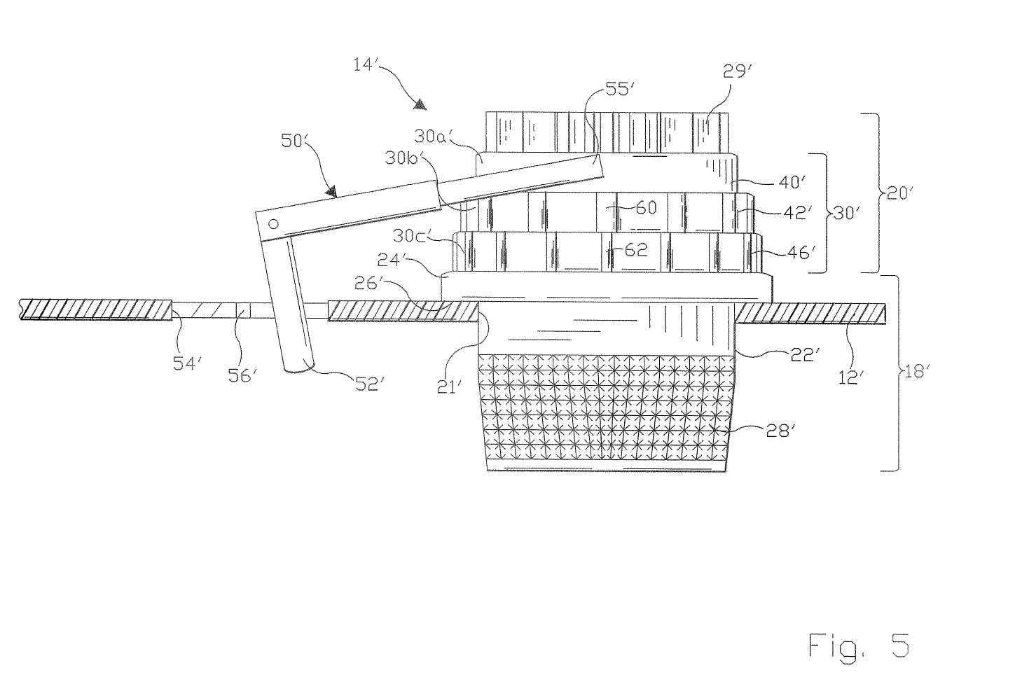

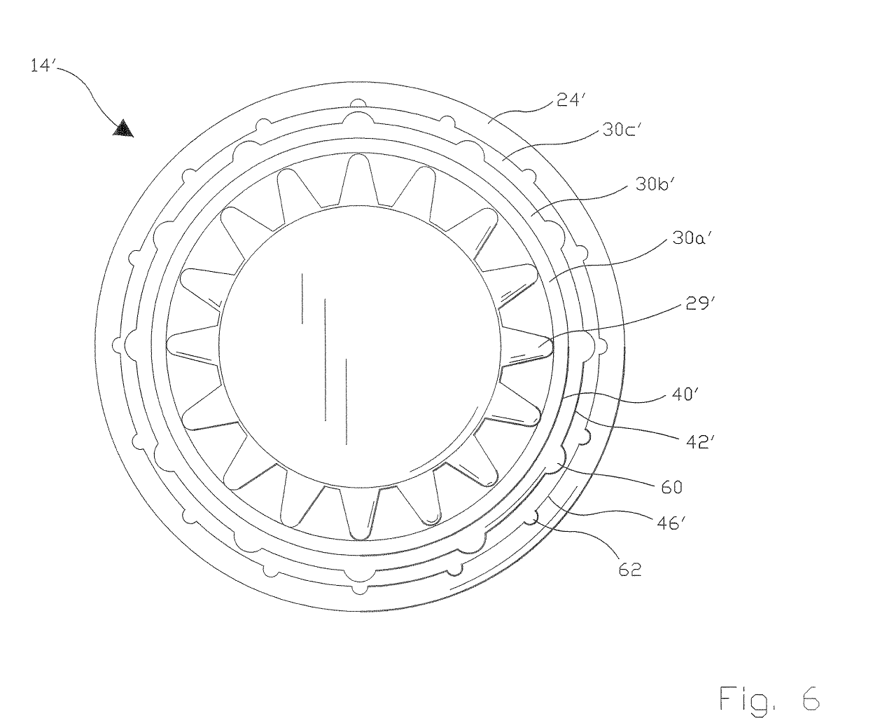

FIGS. 5 and 6 show another embodiment of the invention which includes a rotary actuating mechanism similar to that shown in FIGS. 1 thru 4. Reference numerals for similar structure in respect of the description of FIGS. 1 thru 4 are repeated in FIGS. 5 and 6 with a prime (′) symbol.

FIG. 5 shows a rotary actuating mechanism 14′ disposed in a face plate 12′ of a control module (not shown) for a vehicle center stack (not shown). It is understood that the rotary actuating mechanism 14′ can be employed in other applications as desired. Although the rotary actuating mechanism 14′ shown has a generally cylindrical shape, it is understood that the rotary actuating mechanism 14′ can have other shapes as desired. The rotary actuating mechanism 14′ includes a first portion 18′ and a second portion 20′. The first portion 18′ extends through an aperture 21′ formed in the face plate 12′. An outer surface 22′ of the first portion 18′ is received in the aperture 21′ and terminates at an annular flange 24′. The annular flange 24′ has a first surface 26′ adapted to abut a back side of the face plate 12′. In the embodiment shown, the first portion 18′ is a knob having a plurality of grips 28′ formed thereon.

The second portion 20′ includes a gear 29′ and a plurality of rotary wheels 30′. The gear 29′ is adapted to drive an encoder (not shown) or a potentiometer (not shown) to interface with an electrical system (not shown) of the vehicle. As illustrated in FIGS. 5 and 6, the second portion 20′ further includes a first rotary wheel 30a′, a second rotary wheel 30b′, and a third rotary wheel 30c′ formed thereon. It is understood that the second portion 20′ can include more or less rotary wheels 30′ if desired. The rotary wheels 30′ shown are integrally formed, although it is understood that the rotary wheels 30′ can be formed separately if desired In the embodiment shown, the first rotary wheel 30a′ has a generally smooth outer surface 40′ adapted to provide a sensation of constant resistance. It is understood that the first rotary wheel 30a′ can be adapted to provide any tactile feel as desired. The second rotary wheel 30b′ shown has a generally smooth outer surface 42′ having at least one surface irregularity 60 formed thereon such as an indentation, a protuberance as shown in FIG. 6, a detent, and the like, for example. In the embodiment shown, the surface irregularities 60 are uniformly spaced at a predetermined distance to provide a sensation of increased resistance at a discrete number of positions. It is understood that the second rotary wheel 30b′ can be adapted to provide any tactile feel as desired. The third rotary wheel 30c′ has a generally smooth outer surface 46′ having at least one surface irregularity 62 formed thereon such as an indentation, a protuberance as shown in FIG. 6, a detent, and the like, for example. In the embodiment shown, the surface irregularities 62 are uniformly spaced at a predetermined distance to provide a desired tactile feel. In the embodiment shown, the predetermined distance of the surface irregularities 62 of the third rotary wheel 30c′ is less than the predetermined distance of the surface irregularities 60 of the second rotary wheel 30b′. The desired tactile feel for the third rotary wheel 30c′ is a sensation of increased resistance at a discrete number of positions. It is understood that the third rotary wheel 30c′ can be adapted to provide any tactile feel as desired.

An indexing device 50′ is disposed adjacent the rotary actuating mechanism 14′. The indexing device 50′ is adapted to be positioned on one of the rotary wheels 30′ and travel along the outer surface 40′, 42′, 46′ thereof. As illustrated in FIG. 5, the indexing device 50′ includes a lever 52′ extending through a slot 54′ formed in the face plate 12′. The lever 52′ is accessible to a passenger of the vehicle and is adapted to selectively position a guide 55′ of the indexing device 50′ as desired. The slot 54′ may include at least one groove 56′ adapted to receive the lever 52′ therein at a desired position of the indexing device 50′. It is understood that the indexing device 50′ can be positioned by other mechanical and electromechanical means accessible to the passenger of the vehicle as desired such as a solenoid which cooperates with at least one switch disposed on the face plate 12′, for example. It is further understood that the switch can by any switch type such as a pushbutton, a dial, and the like, for example, and a position of the indexing device 50′ may be monitored using a detector switch (not shown) or by other means of position detection if desired. Position information is useful if a function or a tactile feel of the rotary actuating mechanism 14′ is changed.

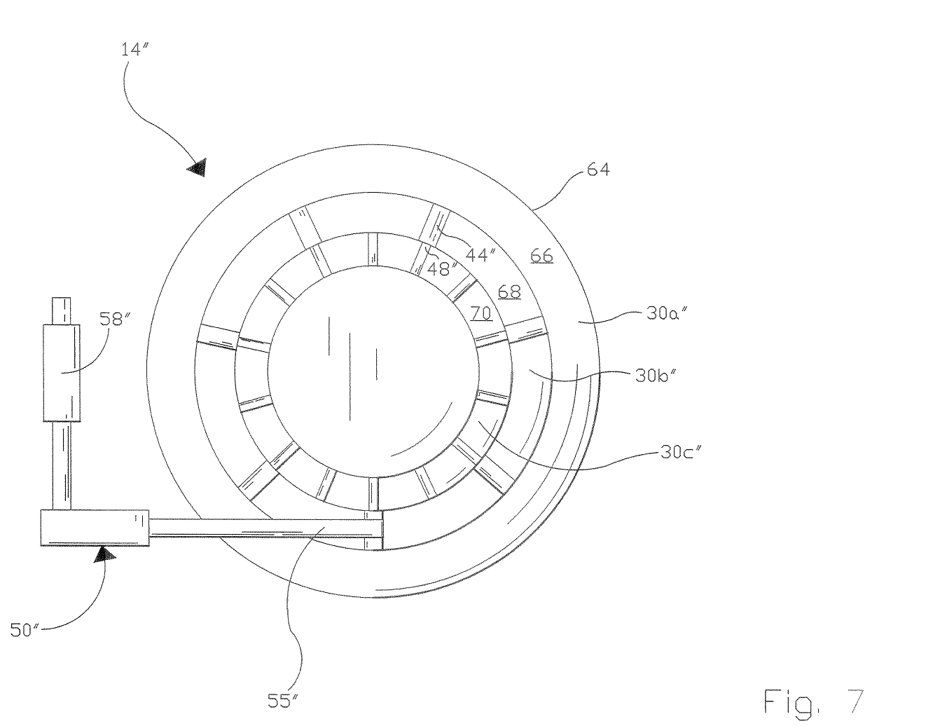

FIG. 7 shows another embodiment of the invention which includes a rotary actuating mechanism similar to that shown in FIGS. 1 thru 6. Reference numerals for similar structure in respect of the description of FIGS. 1 thru 6 are repeated in FIG. 7 with a prime (″) symbol.

FIG. 7 shows a rotary actuating mechanism 14″ for a vehicle center stack (not shown). It is understood that the rotary actuating mechanism 14″ can be employed in other applications as desired. In the embodiment shown, the rotary actuating mechanism 14″ has a substantially disc-shaped portion 64. The disc-shaped portion 64 includes a first rotary wheel 30a″, a second rotary wheel 30b″, and a third rotary wheel 30c″ formed thereon. It is understood that the disc-shaped portion 64 can include more or less rotary wheels if desired. The rotary wheels 30a″′, 30b″, 30c″ shown are integrally formed, although it is understood that the rotary wheels 30a″, 30b″, 30c″ can be formed separately if desired. In the embodiment shown, the first rotary wheel 30a″ has a generally smooth outer surface 66 adapted to provide a sensation of constant resistance. It is understood that the first rotary wheel 30a″ can be adapted to provide any tactile feel as desired. The second rotary wheel 30b″ shown has a generally smooth outer surface 68 having at least one surface irregularity 44″ formed therein such as an indentation, a protuberance, a detent, and the like, for example. In the embodiment shown, the surface irregularities 44″ are uniformly spaced at a predetermined distance to provide a sensation of less resistance at a discrete number of positions. Although, it is understood that the second rotary wheel 30b″ can be adapted to provide any tactile feel as desired. The third rotary wheel 30c″ has a generally smooth outer surface 70 having at least one surface irregularity 48″ formed therein such as an indentation, a protuberance, a detent, and the like, for example. In the embodiment shown, the surface irregularities 48″ are uniformly spaced at a predetermined distance to provide a desired tactile feel. The predetermined distance of the surface irregularities 48″ of the third rotary wheel 30c″ is less than the predetermined distance of the surface irregularities 44″ of the second rotary wheel 30b″. The desired tactile feel for the third rotary wheel 30c″ is a sensation of less resistance at a discrete number of positions. Although, it is understood that the third rotary wheel 30c″ can be adapted to provide any tactile feel as desired.

An indexing device 50″ is disposed adjacent the rotary actuating mechanism 14″. The indexing device 50″ is adapted to be positioned on one of the rotary wheels 30a″, 30b″, 30c′ and travel along the outer surface 66, 68, 70 thereof. The indexing device 50″ includes a solenoid 58″. The solenoid 58″ is adapted to cooperate with at least one switch disposed on the center stack to selectively position a guide 55″ of the indexing device 50″. It is understood that the indexing device 50″ can be positioned by other mechanical and electromechanical means accessible to the passenger of the vehicle as desired such as a lever extending through a slot formed in the center stack, for example. It is further understood that the at least one switch can be any switch type such as a pushbutton, a dial, and the like, for example, and a position of the indexing device 50″ may be monitored using a detector switch (not shown) or by other means of position detection if desired. Position information is useful if a function or a tactile feel of the rotary actuating mechanism 14″ is changed.

Since operation of the rotary actuating mechanism 14 illustrated in FIGS. 1 thru 4 is substantially similar to the rotary actuating mechanism 14′, 14″ illustrated in FIGS. 5 thru 7, for simplicity, only the operation of the rotary actuating mechanism 14 will be described hereinafter.

In operation, the passenger of the vehicle selectively positions the guide 55 of the rotary actuating mechanism 14 on one of the rotary wheels 30 by urging the lever 52 of the indexing device 50, as shown in FIGS. 1 and 2, activating the solenoid 58 by pushing at least one switch 16, as shown in FIG. 4, or by an alternative mechanical and electromechanical means accessible thereto. Thereafter, the passenger rotates the rotary actuating mechanism 14. The rotation of the rotary actuating mechanism causes the guide 55 to travel along the outer surface of the selected rotary wheel 30 providing the desired tactile feel to the passenger.

When the guide 55 is positioned on the first rotary wheel 30a, the tactile feel received by the passenger is a constant resistance. However, when the guide 55 is positioned on either the second rotary wheel 30b or the third rotary wheel 30c, the tactile feel received by the passenger is a lesser resistance at the discrete positions of the surface irregularities 44, 48. It is understood that the passenger can dynamically change the position the indexing device 50 as desired.

From the foregoing description, one ordinarily skilled in the art can easily ascertain the essential characteristics of this invention and, without departing from the spirit and scope thereof, can make various changes and modifications to the invention to adapt it to various usages and conditions in accordance with the scope of the appended claims.

What is claimed is:

1. A rotary actuating mechanism comprising:
a plurality of rotary wheels having an outer surface, wherein the outer surface of at least one of the rotary wheels includes at least one surface irregularity formed thereon; and
an indexing device adapted to selectively engage one of the rotary wheels and travel along the outer surface thereof to provide a desired tactile feel.

2. The mechanism according to claim 1, wherein at least one of the rotary wheels has a generally smooth outer surface.

3. The mechanism according to claim 1, wherein the at least one surface irregularity is an indentation.

4. The mechanism according to claim 1, wherein the at least one surface irregularity is a protuberance.

5. The mechanism according to claim 1, wherein the rotary wheels are substantially disc-shaped.

6. The mechanism according to claim 1, wherein the indexing device is selectively positioned by a mechanical device.

7. The mechanism according to claim 6, wherein the mechanical device includes a lever.

8. The mechanism according to claim 1, wherein the indexing device is selectively positioned by an electromechanical device.

9. The mechanism according to claim 8, wherein the electromechanical device includes a solenoid adapted to be activated by at least one switch.

10. The mechanism according to claim 1, wherein the desired tactile feel is at least one of a constant resistance, a lesser resistance at a discrete position of the at least one surface irregularity, and an increased resistance at a discrete position of the at least one surface irregularity.

11. A rotary actuating mechanism for a vehicle comprising:
a plurality of rotary wheels having a generally smooth outer surface, wherein the outer surface of at least one of the rotary wheels includes at least one surface irregularity formed thereon; and
an indexing device including a guide adapted to contact one of the rotary wheels and travel along the outer surface thereof to provide a desired tactile feel, wherein the guide is selectively positioned by one of a mechanical device and an electromechanical device.

12. The mechanism according to claim 11, wherein the at least one surface irregularity is at least one of an indentation and a protuberance.

13. The mechanism according to claim 11, wherein the mechanical device includes a lever accessible by a passenger of a vehicle.

14. The mechanism according to claim 11, wherein the electromechanical device includes a solenoid adapted to be activated by at least one switch accessible by a passenger of a vehicle.

15. The mechanism according to claim 11, wherein the desired tactile feel is at least one of a constant resistance, a lesser resistance at a discrete position of the at least one surface irregularity, and an increased resistance at a discrete position of the at least one surface irregularity.

16. A control module for a vehicle comprising:
a face plate having at least one switch disposed thereon;
a rotary actuating mechanism including a knob and a plurality of rotary wheels having a generally smooth outer surface, wherein the knob extends through an aperture formed in the face plate, and wherein the outer surface of at least one of the rotary wheels includes at least one surface irregularity formed thereon; and
an indexing device including a guide adapted to contact one of the rotary wheels and travel along the outer surface thereof to provide a desired tactile feel, wherein the guide is selectively positioned by one of a mechanical device and an electromechanical device.

17. The control module according to claim 16, wherein the at least one surface irregularity is at least one of an indentation and a protuberance.

18. The control module according to claim 16, wherein the mechanical device includes a lever extending through a slot formed in the face plate, the lever accessible by a passenger of a vehicle.

19. The control module according to claim 16, wherein the electromechanical device includes a solenoid adapted to be activated by the at least one switch disposed on the face plate.

20. The control module according to claim 16, wherein the desired tactile feel is at least one of a constant resistance, a lesser resistance at a discrete position of the at least one surface irregularity, and an increased resistance at a discrete position of the at least one surface irregularity.
